(19) United States
(12) Patent Application Publication
(10) Pub. No.: US 2023/0121604 A1
(43) Pub. Date: Apr. 20, 2023

(54) DIRECTIONAL ANTENNA OBJECT DETECTION

(71) Applicant: Aro Technology, Inc., Knoxville, TX (US)

(72) Inventors: Heath Erron Wilson, Knoxville, TN (US); Joseph Philip Welch Odom, Knoxville, TN (US); Robert Paul Basil, Lawrenceville, GA (US); Daniel K. Guthrie, Ball Ground, GA (US); Brian Andrew Wong Shui, Atlanta, GA (US); Erick Eladio Rios, New Haven, CT (US)

(21) Appl. No.: 17/871,529

(22) Filed: Jul. 22, 2022

Related U.S. Application Data
(60) Provisional application No. 63/256,989, filed on Oct. 18, 2021.

(51) Int. Cl. G01S 5/04

(52) U.S. Cl. CPC G01S 5/04

(57) ABSTRACT

An object detection system comprises two or more directional antennas arranged such that lobes of the antennas overlap within a designated area or volume. An electronic device detecting signals from at least two of the directional antennas is determined to be inside the area/volume, and a device detecting signals from none of the antennas or only one antenna is determined not to be inside the area/volume. In this manner, the system determines when a user has placed an electronic device within the area/volume, logs the time the electronic device is within the area/volume, and reports the logged time to the user and/or a central system. The area/volume can comprise a platform, a box, or other confined space.

### CROSS REFERENCE TO RELATED APPLICATIONS

This application claims priority to U.S. Provisional Patent Application No. 63/256,989 filed Oct. 18, 2021 and titled “Directional Antenna Object Detection.” The entire contents of the above-identified priority application are hereby fully incorporated herein by reference.

### TECHNICAL FIELD

The technology described herein relates to detecting the location of an electronic device, and, more particularly, to using directional antennas to detect the presence of a smartphone or other object in a confined space.

### BACKGROUND

A major concern for many consumers is the distraction that their smartphones and other electronic devices create. Due to the nature of today's world, such devices are always at arm's reach, and consumers find themselves never taking a break from their devices. The overuse of smartphones and other electronic devices can have effects, such as lower concentration, lack of sleep, stress, and impaired relationships. Parents in particular find it difficult to reduce their children's use of electronic devices, and, in many cases, meals and other family time are routinely interrupted by smartphone notifications. In other cases, individuals find it difficult to focus on their responsibilities in the workplace, or when completing personal activities of enjoyment, such as reading, when their electronic devices are present. Accordingly, many people, and parents, would like to reduce their own, or their family members', use of electronic devices.

Conventional solutions to reducing use of electronic devices, such as smartphone use, include applications that track phone usage. These applications monitor usage and report how much time a user operates the electronic device. These reports can show usage times for particular applications and total usage times for the electronic device during a specified period, such as each day, week, month, or other time period. However, these conventional solutions monitor only use of the electronic device and cannot determine when a user has separated himself from the electronic device. For example, when a user puts a smartphone in their pocket, the smartphone still interrupts the user with notifications, and the user likely will interact with the smartphone in response to the notifications. Additionally, conventional solutions do not promote and incentivize time apart from the electronic device.

### BRIEF DESCRIPTION OF THE DRAWINGS

The drawings are appended hereto and form part of this disclosure.

FIG. 1 is an illustration depicting a conventional omni-directional antenna detecting objects relative to a confined space.

FIG. 2 is a block diagram depicting a system for using directional antennas to detect objects within a confined space.

FIG. 3 is an illustration depicting the object detection system of FIG. 2 using directional antennas to detect objects relative to a confined space.

FIG. 4 is a block flow diagram depicting a method for detecting objects within a confined space using directional antennas.

FIG. 5 is a block diagram depicting a computing machine and a module.

### DETAILED DESCRIPTION

To encourage users to limit smartphone or other electronic device exposure, the innovations described herein monitor when a user places their smartphone in a particular location to avoid use. When the phone is detected in the particular location, the system logs such periods of non-use. Such monitoring incentivizes users to achieve goals of non-use by encouraging and/or rewarding achieved goals. Parents may also encourage children's non-use of smartphones and other electronic devices when the smartphone or electronic device is placed in the particular location. Individuals are advised to place their device in the particular location to perform their desired activities without interruption. Teachers may encourage attention by incentivizing children's placement of their smartphone or other electronic device in the particular location during class. Businesses may motivate employees to place their smartphone in the particular location to boost productivity and engagement during working hours or meetings.

The technology described herein is useful for any electronic device and is particularly useful for smartphones. Many of the examples described herein refer to a smartphone, a phone, or a device as the electronic device. However, this disclosure is not limited to smartphones or phones and any suitable electronic device may be substituted for a smartphone/phone in any of the examples described herein. Additionally, the terms device and electronic device refer generically to any suitable electronic device, including smartphones/phones.

The innovations described herein detect when a phone is placed in a particular location, such as on a designated platform. In certain examples, the platform is located inside a confined space, such as a box or other suitable confined space. The confined space can comprise any suitable shape, such as a cube, sphere, cylinder, rectangular prism, cone, or any suitable shape with any desired number of sides, and the confined space may or may not include a lid.

The innovations described herein also form the technical foundation for a system designed to help people develop a practice of intentional smartphone or other electronic device usage. The technology makes it possible to monitor and record when a user has purposefully put his phone (or other electronic device) away and subsequently to present that information to the user (and perhaps also to others of the user's choosing) in graphical and/or analyzed form. To determine that the user has put his phone away, it is desirable to determine whether the device is within a confined space/volume.

These and other aspects, objects, features, and advantages of the invention will become apparent to those having ordinary skill in the art upon consideration of the following detailed description of illustrated examples.

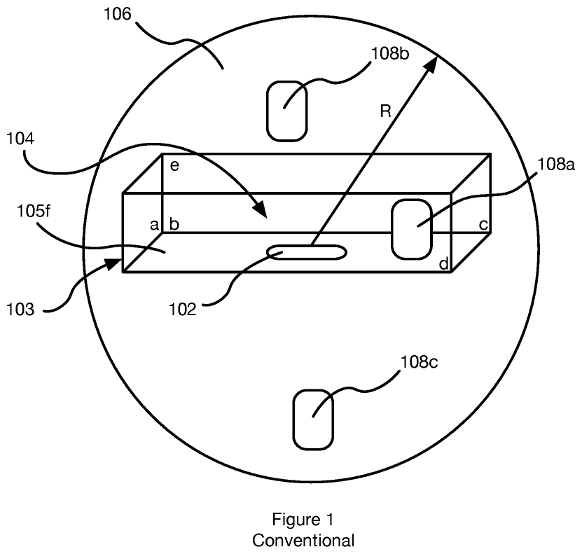

FIG. 1 is an illustration depicting a conventional omni-directional antenna 102 detecting objects relative to a confined space 104. As shown in FIG. 1, the confined space 104 is defined by a box 103 having four sides a, b, c, d; a top e; and a floor 103f. The omni-directional antenna 102 is placed in the confined space 104 on the floor 103f of the box 103. The omni-directional antenna 102 transmits an RF signal 106 that radiates equally in all directions around the omni-directional antenna 102, providing a 360-degree radiation pattern that allows connectivity in all directions. A strength of the RF signal 106 results in transmission in a radius R around the omni-directional antenna 102. A higher strength of the RF signal 106 results in a relatively larger radius R, and a lower strength of the RF signal results in a relatively smaller radius R.

Various electronic devices 108a, 108b, 108c are positioned relative to the box 103 and within the field of the RF signal 106. The electronic devices 108a-108c each comprise an antenna that receives the RF signal 106 transmitted by the omni-directional antenna 102 and processing capability to determine a strength of the RF signal 106 using the received signal strength indication (RSSI). In this manner, each of the electronic devices 108a-108c can determine that it is within the vicinity of the omni-directional antenna 102 by receiving the RF signal 106.

However, each electronic device 108a-108c cannot reliably determine whether the device is inside or outside the confined space 104 of the box 103. For example, only device 108a in FIG. 1 is located within the confined space 104. Devices 108b, 108c are located outside of the confined space 104. Even though each device 108a-108c is detecting the RF signal 106 from the omni-directional antenna 102, each device 108a-108c is only able to determine that it is within the range of the omni-directional antenna 102. The devices 108a-108c cannot determine that device 108a is within the confined space 104 and that devices 108b, 108c are outside the confined space 104.

Additionally, the operating environment affects propagation of the RF signal 106 because of multipath distortion. Even attenuating the RF signal 106 to a very low level would not alleviate multipath constructive/destructive forces. Due to multipath distortion, the signal would sometimes be too weak inside the confined space 104 and too strong outside the confined space 104 for accurate determination of whether the devices 108a-108c are inside the confined space 104.

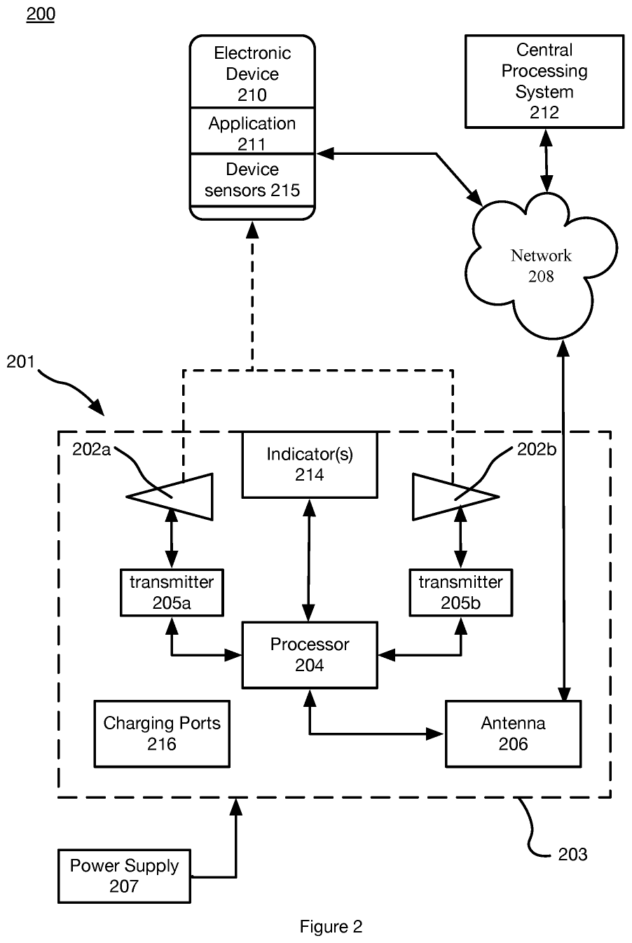

FIG. 2 is a block diagram depicting a system 200 for using directional antennas to detect objects within a confined space, in accordance with certain examples. As shown in FIG. 2, the system 200 comprises an object detection system 201, an application 211 executing on an electronic device 210, a central processing system 212, and a network 208 via which the various components communicate.

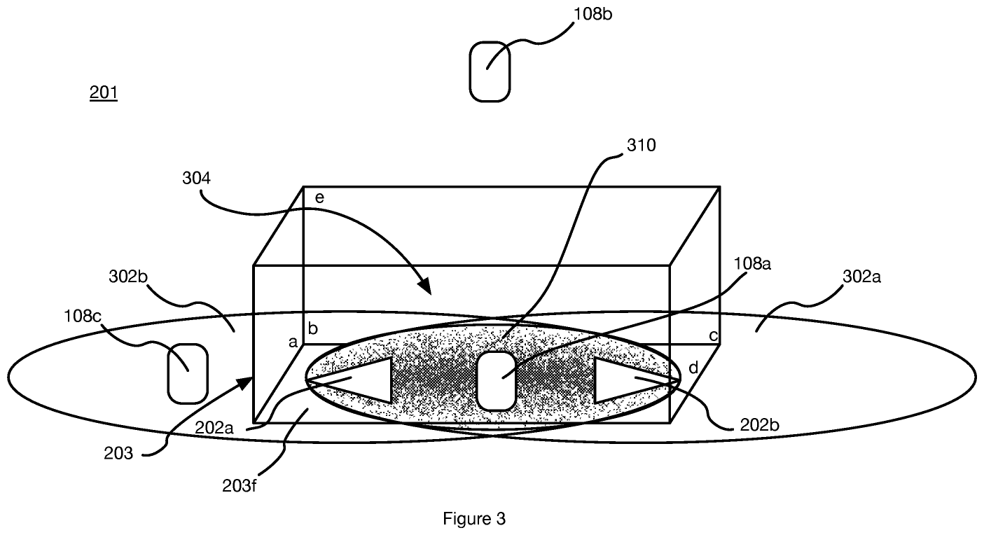

As shown in FIG. 2 (and with reference to FIG. 3), the object detection system 201 comprises a box 203 in which various components of the system 201 are supported. The object detection system comprises directional antennas 202a, 202b. The directional antennas 202a, 202b can be low-power, directional, Bluetooth® antennas. However, any suitable directional antenna can be used. Each directional antenna 202a, 202b broadcasts a signal that includes an identification of the antenna.

The object detection system 200 further comprises one or more processors 204 (referred to generally herein as the processor 204). In operation, the processor 204 controls the outputs of the directional antennas 202a, 202b by controlling transmitters 205a, 205b corresponding to the directional antennas 202a, 202b, respectively. While a single processor may control both antennas, each antenna may be controlled by a separate processor. The processor 204 instructs the directional antennas 202a, 202b to broadcast, and controls the power output of the directional antennas 202a, 202b.

A power supply 207 provides power to the various components of the object detection system 200. The power supply 207 comprises any suitable power supply, such as AC or DC power. The power supply 207 may comprise a rechargeable battery, a direct AC connection, or a direct DC connection.

The object detection system 200 comprises one or more charging ports 216 powered by the powers supply 202. The charging ports 216 can comprise any suitable charging port, such as a powered port that receives a charging cord coupled to an electronic device or a wireless charger on which an electronic device is placed to charge a battery of the electronic device.

The object detection system 200 also comprises an antenna via which the processor can send and receive information to/from the electronic device 210 and a central processing system 212 via a network 208.

Indicators 214 of the object detection system 200 comprise a speaker, a light, a display, or any other suitable peripheral device that provides a notification external to the box 203 when instructed by the processor 204.

FIG. 3 is an illustration depicting the object detection system 201 using the directional antennas 202a, 202b to detect objects relative to a confined space 304 defined by the box 203, in accordance with certain examples. As shown in FIG. 3, the confined space 304 is defined by a box 203 comprising four sides a, b, c, d; a top e; and a floor 203f. Two directional antennas 202a, 202b are positioned in the confined space 304 opposite each another on the floor 203f of the box 203. Each directional antenna 202a, 202b is disposed near an opposite side of the confined space 304 and is configured to transmit toward the other directional antenna.

A directional antenna is a type of antenna that distorts its RF radiation pattern so that more energy is transmitted in a desired direction and less energy is transmitted in other directions. As shown in FIG. 3, the directional antenna 202a transmits an RF signal toward the directional antenna 202b as represented by the antenna lobe 302a. And, the directional antenna 202b transmits an RF signal toward the directional antenna 202a as represented by the antenna lobe 302b. Although depicted in two dimensions in FIG. 3, the antenna lobes 302a, 302b are representational of a three-dimensional signal transmission from the directional antennas 202a, 202b, respectively.

Most of the energy from the directional antennas 202a, 202b is transmitted in the directions shown by the antenna lobes 302a, 302b in FIG. 3, and much less energy is transmitted in other directions. For example, most of the energy from the directional antenna 202a is transmitted forward toward the directional antenna 202b as shown by the antenna lobe 302a, and much less energy is transmitted in the areas not encompassed by the antenna lobe 302a. Similarly, most of the energy from the directional antenna 202b is transmitted forward toward the directional antenna 202a as shown by the antenna lobe 302b, and much less energy is transmitted in the areas not encompassed by the antenna lobe 302b. For either antenna 202a, 202b, the difference in power between the two sides of the antenna can be as great as 10 dB or more.

The antenna lobes 302a, 302b overlap in region 310 between the directional antennas 202a, 202b, as depicted by the stippled region 310 in FIG. 3. The signal strength of the directional antennas 202a, 202b is controlled such that the region 310 is disposed sufficiently within the confined space 304 to allow determining when an electronic device is within the confined space 304. Thus, when an electronic device detects signals from both directional antennas 202a, 202b, the electronic device is determined to be within the confined space 304. An electronic device detecting signals from only one directional antenna or neither directional antenna is determined not to be within the confined space 304.

As shown in FIG. 3, the electronic device 108a is disposed within the region 310 of the overlapping lobes 302a, 302b. In this case, the electronic device 108a detects signals from both antennas 202a, 202b and is determined to be within the confined space 304. In contrast, the electronic device 108c is located only within the lobe 302b from the directional antenna 202b. The electronic device 108c detects only the signal from the directional antenna 202b and is determined not to be within the confined space 304. Similarly, the electronic device 108b is not located in either the lobe 302a or the lobe 302b. The electronic device 108b will not detect a signal from either the directional antenna 202a or the directional antenna 202b and is determined not to be within the confined space 304.

In certain examples, to determine whether an electronic device is inside or outside the confined space 304, the transmitters 205a, 205b for the radio(s) connected to the antennas 202a, 202b can be attenuated to within 10 dB of the receiver sensitivity of the electronic device, in which case the electronic device will detect signals from both antennas 202a, 202b when located inside the confined space 304 and from one or zero antennas when located outside the confined space 304. While multipath distortion may still play a role in this configuration, such distortion is much less likely to lead to errors compared to systems using the omni-directional antenna, as the undesired paths are at lower strengths. The lower strengths decrease the likelihood that the distortions will add up to a detectable level in undesired directions.

Shielding, such as RF absorptive material, can be added to the lower portion 203f of the confined space under the directional antennas 202a, 202b to increase performance, if desired. The shielding increases the relative difference of the strengths of the signals inside and outside the confined space 304 with minimal effect on the RF performance of other radios in the electronic device, such as cellular, Wi-Fi, and UWB radios. Additionally, the shielding diminishes multipath distortions that can constructively add and destructively subtract from the RF power of the directional antennas 202a, 202b. The shielding also can be provided on the sides and/or top of the confined space to completely surround the electronic device therein, for example, by shielding the walls and/or lid of a confined space that the antennas are monitoring.

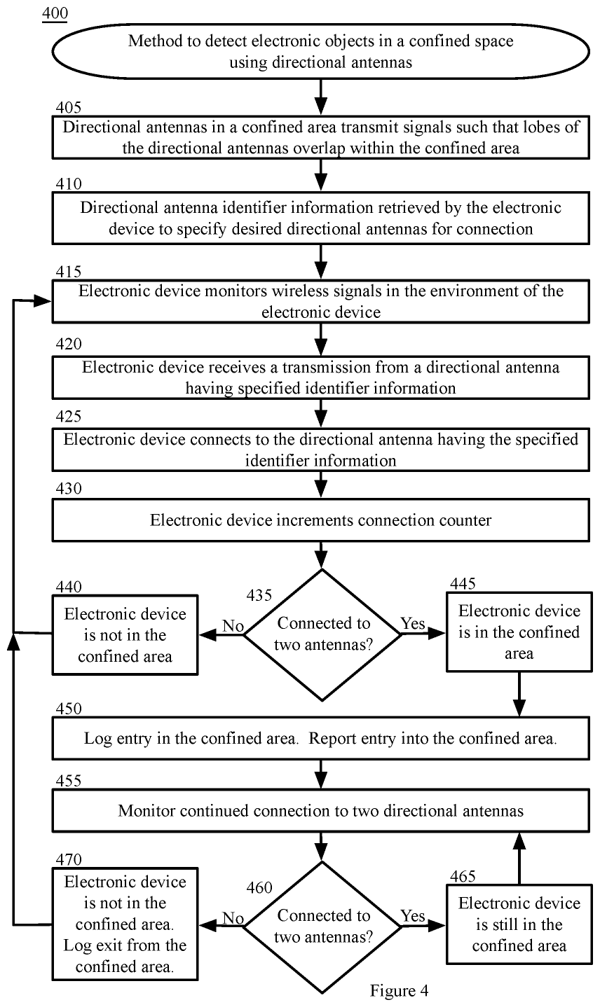

The components of the systems 200 and 201 will be described in further detail hereinafter with reference to the processes described in FIG. 4. FIG. 4 is a block flow diagram depicting a method for detecting objects within a confined space using directional antennas, in accordance with certain examples.

In block 405, directional antennas 202a, 202b in the confined space 304 transmit signals such that lobes 302a, 302b of the directional antennas 202a, 202b overlap within the confined space 304, as described previously with reference to FIG. 3.

Each directional antenna 202a, 202b broadcasts a signal that includes an identification of the antenna. In certain examples, the identification can include a general identifier. The general identifier identifies an owner of the antenna, such as a developer, manufacturer, brand, or other suitable identity. For example, each antenna may have a general identifier of BRAND. Detection of two antennas having the same general identifier indicates that a device, such as the electronic device 210, is in a confined space, such as the confined space 304 referenced in FIG. 3. The identification of the antenna also may include a specific identifier. The specific identifier identifies the specific antenna. For example, the first directional antenna 202a may have an identifier of BRAND-ANTENNA1, and the second directional antenna 202b may have an identifier of BRAND-ANTENNA2. Detection of two antennas having the same general identifier and different specific identifiers indicates that the device is in a confined space, such as the confined space 304 referenced in FIG. 3. Antennas assigned to a particular confined space, such as the confined space 304, also may include a confined space identifier. For example, the first directional antenna 202a may have an identifier of BRAND-BOXA-ANTENNA1, and the second directional antenna 202b may have an identifier of BRAND-BOXA-ANTENNA2. Alternatively, as the specific antenna identifier is optional, the first and second directional antennas 202a, 202b may have identifiers of BRAND-BOXA. Detection of two antennas with the same general identifier and having the same confined space identifier indicates that the device is in a particular confined space having the indicated confined space identifier.

In block 410, directional antenna identifier information is retrieved by the electronic device 210 to specify desired directional antennas for connection. For example, the application 211 executing on the electronic device 210 retrieves general identifier information associated with known confined spaces 304, such as by developer, manufacturer, brand, or other suitable identity, and communicates the general identifier information to the operating system of the electronic device 210.

In block 415, the application 211 executing on the electronic device 210 monitors wireless signals in its environment, either directly or indirectly via the device's operating system, and, in block 420, the electronic device 210 receives a transmission from a directional antenna having specified identifier information (see dashed lines in FIG. 2 connecting the directional antennas 202a, 202b to the device 210). For example, an antenna of the electronic device 210 receives signals, including identifier information, broadcast by the directional antenna 202a and the operating system reads the general identifier from identifier information in the received signal. The operating system compares the general identifier from the received signals to the general identifier provided by the application in block 410.

If the general identifiers match, the operating system of the device 210 connects, in block 425, to the directional antenna 202a and communicates the identifier information for each matching signal to the application 211, together with an indication that the device 210 has connected to the directional antenna 202a corresponding to the matching signal.

In block 430, the application 211 receives the connection indication and the identifier information and increments a counter for each completed connection. For example, if the initial counter equals “zero,” the application 211 increments the counter to “one” based on the connection to the directional antenna 202a.

In block 435, the application 211 then examines how many distinct connections were completed based on the number of connections reported by the operating system and indicated by the counter. If the application 211 determines in block 435 that a connection was made with only one antenna (or zero antennas) with the general identifier, then the method 400 proceeds to block 440 in which the application 211 determines that the electronic device 210 has not been placed in a confined space 304. The method 400 then returns to block 415 and continues to monitor for additional signals.

In this manner, when the electronic device 210 is in the confined space 304, the device 210 will repeat blocks 415-435 to receive a transmission from the directional antenna 202b, connect to the directional antenna 202b, and increment the connection counter to “two.” Then, referring back to block 435, if the application 211 determines that a connection was made from at least two antennas with the general identifier, the method 400 proceeds to block 445 in which the application 211 determines that the electronic device 210 has been placed in a confined space, such as the confined space 304.

In block 450, the application 211 logs entry of the electronic device 210 in the confined space 304 and may report entry to the system 201 or to any device monitoring this operation, such as the central processing system 212. For example, the application 211 of the electronic device 210 instructs a communication system of the device 210 to transmit, via the network 208, a notification to the system 201 and/or the central processing system 212. The notification reports that the device 210 is in the confined space 304.

The application 211 also may read the confined space identifier (if included) and the antenna identifier from the identifier information for each completed connection. The confined space identifier identifies the specific confined space in which the device is located. The antenna identifiers can be used by the application to verify connections to separate antennas, if desired, by determining that connections reported by the operating system have distinct antenna identifiers.

Thus, when the application 211 determines that the device 210 is simultaneously receiving two signals with the appropriate identifier or identifiers, the device is considered to have entered the confined space 304, and the application 211 logs the beginning of a session for the electronic device 201 being in the confined space 304.

In block 455, the application 211 continues to monitor data, including, but not limited to, wireless signals, the connection counter, and accelerometer, magnetometer, gyroscopic output of the device 210, to determine whether the electronic device 210 remains in the confined space 304 or has been removed from the confined space 304.

The application 211 continues to monitor connections reported by the operating system to determine when the electronic device 210 is removed from the confined space 304. In block 460, as long as the operating system continues to receive signals from at least two antennas, such as the directional antennas 202a, 202b, the application 211 determines in block 465 that the electronic device 210 is still in the confined space 204. In this case, the method 400 returns to block 455 to continue to monitor antenna connections.

In this manner, the application 211 will maintain that the device 210 remains in the confined space 304 until the operating system reports loss of connection with at least one of the antennas. When the application 211 determines in block 460 that the device 260 has lost connection with one antenna (or both antennas), the method 400 proceeds to block 470 in which the application determines that the electronic device has been removed from the confined space 304. The application 211 logs removal of the electronic device 210 from the confined space 304 indicating the end of the session and may report removal to the system 201 or to any device monitoring this operation, such as the central processing system 212.

From block 470, the method 400 returns to block 415 to monitor new connections to determine when the device 210 is returned to the confined space 304 or another confined space.

Loss of one antenna connection is sufficient to determine that the device 210 has been removed from the confined space. To provide more reliable results, the application 211 can be configured to monitor for loss of connection from both antennas to determine that the device has been removed from the confined space. Additionally, to further enhance the accuracy of detecting when the device has been removed, information from other device sensors 215 (FIG. 2) can be combined with the notification of antenna connection loss to determine removal of the device. For example, information may be used from device sensors such as an accelerometer, a gyroscope, a near field communication (NFC) antenna, a magnetometer, or any other suitable sensor of the device 210. The operating system reports information from these sensors that indicates movement of the device. When the application receives sensor movement information and a notification of a connection loss for at least one antenna, the application determines that the device has been removed from the confined space. This process can increase removal detection speed based on loss of connection to only one antenna because notification of connection loss for the second antenna may be delayed. The process also improves removal detection accuracy since the device may lose antenna connections even while remaining in the confined space. In this case, if positive sensor data is required to determine device removal from the confined space, the application will not determine device removal unless connection loss and movement sensor data are received.

Information from accelerometers and gyroscopes typically corresponds to movement of a device. For NFC, the system 200 and the device have NFC capability and establish an NFC connection when the device is placed in the confined space. If the device is moved away from the confined space, the NFC connection is lost and is reported to the application. Similarly for a magnetometer, one of the device 210 and the system 201 includes a magnetometer, and the other one of the device 210 and the system 201 includes at least one magnet. When the device is placed in the confined space, the magnet is then located close enough to the magnetometer to be detected by the magnetometer. If the device is moved away from the confined space, the magnetometer will lose detection of the magnet and that loss is reported to the application.

The antenna 206 of the system 201 receives communications, for example, notifications, from the application 211 executing on the electronic device 210 and forwards the communications to the processor 204 of the system 201 to process the received communications. For example, if the application 211 communicates a notification that the device 210 has been placed into or removed from the confined space 304, the processor 204 can receive the notification and, in response, output an indication acknowledging placement or removal, such as instructions to the one or more indicators 214 to output a light, sound, message, or other suitable indicator based on peripheral devices coupled to the processor 204 of the system 201.

One or multiple processors 204 can be utilized. For example, the system 200 may comprise a single processor 204 that operates the directional antennas 202a, 202b and that processes information received by and transmitted from the system 201. The system 201 may comprise two processors 204, where one processor 204 operates the directional antennas 202a, 202b and one processor 204 processes information received by and transmitted from the system 201. Any suitable number of processors 204 may be utilized.

The innovations described herein are suitable for any electronic device that can receive and/or transmit signals as described herein. For example, the electronic devices can include smartphones, smart watches, laptops, tablets, audio devices, Bluetooth® inventory-type tags, consumer electronics, and any other suitable electronic devices. Additionally, although described herein with reference to Bluetooth® antennas, any suitable wireless communication technology may be used. For example, Wi-Fi, NFC, ultra-wide band (UWB), or any other suitable technology may be used.

In an alternative example, the system 201 can comprise the application that detects placement in and/or removal of an electronic device from the confined space. In this example, the electronic device broadcasts a signal with an identity of the device. The directional antennas in the confined space receive signals and communicate those signals to the processor in the confined space. An application executing on the processor monitors the device identities received by each antenna. When the application determines that both antennas received a signal from (and/or connected to) a particular electronic device, based on the device identity of the particular electronic device, the application determines that the particular electronic device is in the confined space. Then, when the application determines that at least one or both antennas are not receiving the signal from the particular electronic device, the application determines that the particular electronic device has been removed from the confined space. The confined space processor can communicate notifications to the application executing on the electronic device, or to any device monitoring this operation, indicating placement in, or removal from, the confined space. The confined space processor also can monitor and log duration in the confined space similarly to the previous example.

Although described previously with regard to a device comprising an operating system and an application determining when the device is placed in the confined space, this system can be utilized in other configurations. For example, an embedded platform may comprise the communication technologies and an application that performs the functions of both the operating system and the application described previously. In this case, the application receives inputs directly from the communication technologies and sensors; monitors the connections, loss of connections, and sensor data (if applicable); and determines placement/removal of the device in/from the confined space.

The examples described previously utilized two directional antennas. However, any suitable number of directional antennas may be used. Multiple antennas can be oriented to broadcast toward a point that is centered between all antennas. In this manner, the lobes of the antennas will overlap in the space between the antennas. When using more than two antennas, the application can require receiving signals from all, two or more, or any specified multiple number of antennas to determine that an electronic device has been placed in the confined space. And, when using more than two antennas, the application can require loss of signals from all, all but one, two or more, or any specified multiple number of antennas to determine that an electronic device has been removed from the confined space.

Although described previously with regard to a confined space in a box, the innovations described herein can be applied to a broad range of spaces. The innovations described herein detect when a phone is placed in a particular location, such as on a designated platform, in a box, or other confined space. For example, the platform can be the bottom 203f depicted in FIG. 3 (without the sides and top), and the bottom 203f defines this confined space. In this case, the confined space is an area, and the innovations described herein identify when an electronic device is located in the area. In certain examples, the platform is located inside a box or other suitable enclosure. As described previously, the particular location can be an enclosure, such as the box 203 depicted in FIG. 3. In this case, the confined space is a volume, and the innovations described herein identify when an electronic device is located in the volume. The confined space can comprise any suitable shape, such as a cube, sphere, cylinder, rectangular prism, cone, or any suitable shape with any desired number of sides, and the confined space may or may not include a lid.

The confined space can be any suitable size. For example, the confined space can be sized for one or multiple electronic device(s), and the confined space can be sized to accommodate any desired electronic device. A larger confined space can accommodate more electronic devices and/or larger electronic devices. One system 200 can determine when multiple smartphones are in the same confined space.

The innovations described herein also are suitable for larger confined spaces. For example, directional antennas can be positioned around a room (such as a conference room, classroom, or other suitable space) and arranged so lobes of the antennas overlap inside the room. Then, electronic devices can be detected in the room or having left the room in a manner similar to detecting an electronic device with regard to a platform or smaller confined space. In this manner, occupants can be monitored in a space based on occupants associated with the electronic devices. The number and power of antennas can be selected to cover the desired area. This configuration also is useful to determine when an electronic device passes a location, such as a security checkpoint. In this case, the antennas may be oriented in a vertical plane.

The directional antennas can be arranged with regard to the confined space in any suitable manner. For example, the directional antennas can be arranged on a surface of a platform or on the interior, bottom surface of a box. However, any suitable arrangement of the directional antennas can be utilized to situate the overlapping portion of the antenna lobes in the desired location. For example, the directional antennas can be disposed within the platform or box bottom, on one or more sides of the box, or any other suitable relationship with the confined space. Additionally, the directional antennas can be concealed on the platform or within the box. For example, an additional layer of suitable material may be positioned over the antennas to conceal the antennas.

Although described as detecting electronic devices, the systems and methods described herein can be used to monitor non-electronic items. For example, a Bluetooth® tag can be attached to a piece of jewelry, a powered-off electronic device, or other valuable. Then, the systems can monitor a location of the valuable using signals from the tag and can report entry/removal of the valuable from the location.

Individuals are incentivized to use the system through an interactive software application that resides on the user's electronic device and pairs with the hardware unit to graphically display goals, completed sessions, and progress towards user goals set around time spent apart from their electronic device. The application experience may be customized to individual user goals established by the user, as well as logging user activities completed during paired hardware sessions. Reports, badges, and tailored messaging features included in the application further incentivize and coach users towards improving healthier user habits around use of smartphones and other electronic devices. Other incentives and systems of encouragement exist through community groups or instructional content available within the application.

Example Systems

The example systems and methods are described herein with respect to particular components of the example directional antenna object detection systems and methods. However, any suitable components may be used to perform those methods and functions, and this disclosure is not limited to the particular components described herein.

The operations described herein can be implemented as executable code stored on a computer or machine readable non-transitory tangible storage medium (e.g., floppy disk, hard disk, ROM, EEPROM, nonvolatile RAM, CD-ROM, flash drive, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

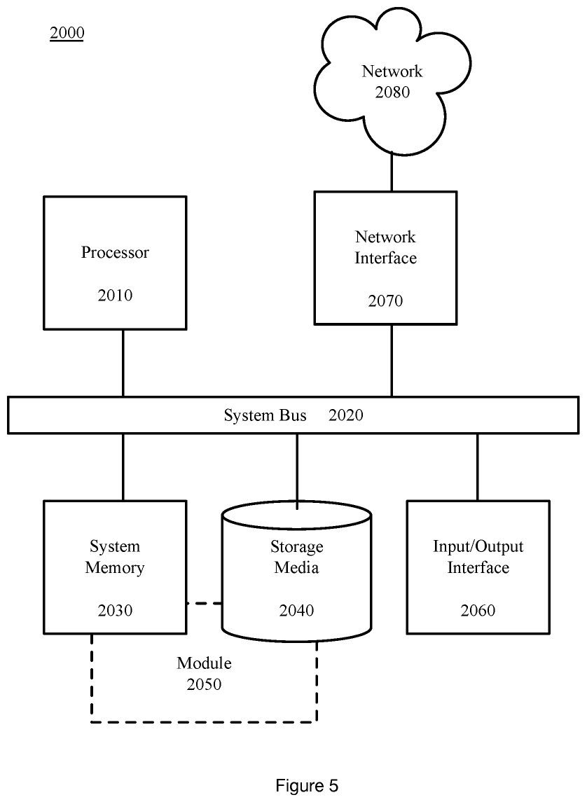

FIG. 5 is a block diagram depicting a computing machine 2000 and a module 2050 in accordance with certain examples. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components, for example, a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain examples, the processor 2010 along with other components of the computing machine 2000 may be a virtualized computing machine executing within one or more other computing machines.

The system memory 2030 may include non-volatile memories, for example, read-only memory (ROM), programmable read-only memory (PROM), erasable programmable read-only memory (EPROM), flash memory, or any other device capable of storing program instructions or data with or without applied power. The system memory 2030 may also include volatile memories, for example, random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device, for example, the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid state drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules, for example, module 2050, data, or any other information. The storage media 2040 may be part of, or connected to, the computing machine 2000. The storage media 2040 may also be part of one or more other computing machines that are in communication with the computing machine 2000, for example, servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits, for example, microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, for example, small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or analog communication media, for example, fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain examples, any of the processor 2010, the other elements of the computing machine 2000, or the various peripherals discussed herein may be integrated into a single device, for example, a system on chip (SOC), system on package (SOP), or ASIC device.

Examples may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing examples in computer programming, and the examples should not be construed as limited to any one set of computer program instructions. Further, a skilled programmer would be able to write such a computer program to implement an example of the disclosed examples based on the appended flow charts and associated description in the application text. Therefore, disclosure of a particular set of program code instructions is not considered necessary for an adequate understanding of how to make and use examples. Further, those skilled in the art will appreciate that one or more aspects of examples described herein may be performed by hardware, software, or a combination thereof, as may be embodied in one or more computing systems. Additionally, any reference to an act being performed by a computer should not be construed as being performed by a single computer as more than one computer may perform the act.

The examples described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the examples presented previously are illustrative, and, in alternative examples, certain acts can be performed in a different order, in parallel with one another, omitted entirely, and/or combined between different example examples, and/or certain additional acts can be performed, without departing from the scope and spirit of various examples. Accordingly, such alternative examples are included in the scope of the following claims, which are to be accorded the broadest interpretation so as to encompass such alternate examples.

Although specific examples have been described above in detail, the description is merely for purposes of illustration. It should be appreciated, therefore, that many aspects described above are not intended as required or essential elements unless explicitly stated otherwise.

Modifications of, and equivalent components or acts corresponding to, the disclosed aspects of the examples, in addition to those described above, can be made by a person of ordinary skill in the art, having the benefit of the present disclosure, without departing from the spirit and scope of examples defined in the following claims, the scope of which is to be accorded the broadest interpretation so as to encompass such modifications and equivalent structures.

What is claimed is:

1. A system to detect objects using directional antennas, comprising:
a platform;
a first directional antenna and a second directional antenna arranged on the platform, a first transmission lobe of the first directional antenna transmitting toward the second directional antenna, a second transmission lobe of the second directional antenna transmitting toward the first directional antenna, the first and second transmission lobes overlapping at an area disposed at least partially between the first directional antenna and the second directional antenna, and the area of the overlapping lobes corresponding to a specified space above the platform; and
at least one processor controlling a first transmission output of the first directional antenna to produce the first transmission lobe and controlling a second transmission output of the second directional antenna to produce the second transmission lobe.

2. The system of claim 1, further comprising four side walls coupled to the platform to define an enclosure, at least a portion of the specified space disposed within the enclosure.

3. The system of claim 2, the enclosure comprising an openable lid coupled to at least one of the four side walls.

4. The system of claim 2, wherein the enclosure is a box.

5. The system of claim 2, further comprising a power source providing power to the at least one processor and the first and second directional antennas.

6. The system of claim 5, further comprising at least one electronic device charger coupled to the power source and disposed within the enclosure.

7. The system of claim 6, the electronic device charger comprising a wireless charging pad.

8. The system of claim 6, the electronic device charger comprising a port configured to receive a cord to charge an electronic device.

9. A system to detect objects using directional antennas, comprising:
an enclosure comprising an interior defined by a bottom and at least one wall; and
a first directional antenna and a second directional antenna arranged such that a first transmission lobe of the first directional antenna transmits toward the second directional antenna and a second transmission lobe of the second directional antenna transmits toward the first directional antenna, the first and second transmission lobes overlapping at an area disposed at least partially between the first directional antenna and the second directional antenna and at least partially within the interior of the enclosure.

10. The system of claim 9, further comprising at least one processor controlling a first transmission output of the first directional antenna to produce the first transmission lobe and controlling a second transmission output of the second directional antenna to produce the second transmission lobe.

11. A system to detect objects using directional antennas, comprising:
two directional antennas arranged to direct their output toward each other such that transmission lobes of the two directional antennas overlap between the two directional antennas, an area of the overlapping lobes corresponding to a specified space; and
an application executing on an electronic device, the application receiving information from the two directional antennas and determining that the electronic device is located within the specified space based on a determination that information has been received from both of the two directional antennas.

12. The system of claim 11, wherein the application executing on the electronic device determines that the electronic device has been removed from the specified space based on a determination that the electronic device lost connection with at least one of the two directional antennas.

13. The system of claim 12, wherein the application executing on the electronic device further:
logs a first time associated with the determination that the electronic device is located within the specified space;
logs a second time associated with the determination that the electronic device has been removed from the specified space;
determines a duration that the electronic device was within the specified space based on the first time and the second time; and
logs the duration that the electronic device was within the specified space.

14. The system of claim 11, wherein the electronic device comprises a smartphone, a smart watch, a laptop, a tablet, an audio device, an inventory-type tag, or a consumer electronic device.

15. The system of claim 11, further comprising a platform, the two directional antennas being oriented such that the specified space is adjacent a top of the platform.

16. The system of claim 11, further comprising a box, the two directional antennas being oriented such that the specified space is inside the box.

17. The system of claim 11, wherein the specified space comprises a platform, a box, a room, or a location.

18. A method to detect objects using directional antennas, comprising:
receiving, by an electronic device, information from a plurality of directional antennas associated with a specified space; and
determining, by the electronic device, that the electronic device is located within the specified space based on a determination that the electronic device received the information from the plurality of directional antennas within a specified time period.

19. The method of claim 18, further comprising:
determining, by the electronic device, that the electronic device has been removed from the specified space based on a determination that the electronic device lost a connection with at least two of the plurality of directional antennas.

20. The method of claim 19, further comprising:
logging a first time associated with the determination that the electronic device is located within the specified space;
logging a second time associated with the determination that the electronic device has been removed from the specified space;
determining a duration that the electronic device was within the specified space based on the first time and the second time; and
logging the duration that the electronic device was within the specified space.

21. The method of claim 18, wherein the specified space comprises a platform, a box, a room, or a location.
